(19) United States
(12) Patent Application Publication
(10) Pub. No.: US 2016/0355691 A1
(43) Pub. Date: Dec. 8, 2016

(54) PROCESS FOR PROTECTING AN ELECTRONIC DEVICE WITH A HYDROPHOBIC COATING

(71) Applicants: Thomas Kim, Chicago, IL (US); Syed Taymur Ahmad, Chicago, IL (US); Bruce Acton, Bettendorf, IA (US)

(72) Inventors: Thomas Kim, Chicago, IL (US); Syed Taymur Ahmad, Chicago, IL (US); Bruce Acton, Bettendorf, IA (US)

(21) Appl. No.: 15/172,692

(22) Filed: Jun. 3, 2016

Related U.S. Application Data
(60) Provisional application No. 62/170,941, filed on Jun. 4, 2015.

(51) Int. Cl. C09D 5/08; C09D 133/16; C09D 183/04

(52) U.S. Cl. CPC C09D 5/08; C09D 183/04; C09D 133/16

(57) ABSTRACT

Methods for protecting an electronic device from contaminants by applying multiple polymeric layers on the vital components of a device are disclosed. In one embodiment, the method comprises applying a multilayered, hydrophobic coating that is inert to electrical conductivity on one or more components of the device. The method includes applying to a component of a device a first layer comprising a first polymer, such as a silicone-based polymer, and a second layer comprising a second polymer, such as an acrylic-based polymer on top of the first layer. Each of the first and second layers exhibits a water contact angle greater than 90°, such as at least 110°. Electronic devices that are protected by such multilayered, hydrophobic coatings are also disclosed. Non-limiting examples of such devices include smart phones, computers, and gaming devices.

This application claims priority to U.S. Provisional Application No. 62/170,941, filed on Jun. 4, 2015, which is incorporated herein by reference in its entirety.

The present disclosure generally relates to methods of protecting electronic devices, such as a cell phone or computer, by applying multiple polymer layers to the individual device components that render the resulting device hydrophobic. The present disclosure also relates to devices protected by such polymeric multilayers, including any device containing a printed circuit board.

### BACKGROUND

Electronic devices are comprised of electrically conductive and insulating components, which can be adversely affected by a variety of contaminants. Exposure to liquids like water, will often lead to corrosion of these components that will eventually destroy the function of the electronic device. In addition, as such devices become more sophisticated with increased functionality, they are being used in more hazardous environments that require greater protection from contaminants, especially liquids.

As a result, water resistant coatings are becoming a more popular form of protection of such devices. However, most water resistance technologies provide only one form of nano coating (one molecule) and one method of application. Accordingly, there is need for coated electronic devices and methods that allow for protection of electronic devices from contaminates, that comprises multiple coatings or different chemistries, as well as multiple methods for applying such coatings.

### SUMMARY

In view of the foregoing, there is disclosed a method for protecting an electronic device by applying multiple polymeric layers on the vital components of the device. In one embodiment, the disclosed method generally comprises applying to at least one internal component of a device a combination of polymers comprising: a first layer comprising a first polymer having a water contact angle greater than 90° after curing; and a second layer comprising a second polymer having a water contact angle greater than 90° after curing, wherein the first polymer and the second polymer form a multilayer, hydrophobic coating on top of the at least one internal component of the electronic device.

There is also disclosed electronic devices that have enhanced hydrophobic properties as a result of being treated with the disclosed method. In one embodiment, the electronic device comprises at least one multilayered, hydrophobic coating on one or more components of the device. As stated, the hydrophobic coating comprises a first layer in direct contact with one or more internal components of the device, wherein the first layer comprises a first polymer having a water contact angle greater than 90 degrees, and a second layer on top of the first layer, the second layer comprising a second polymer also having a water contact angle greater than 90 degrees.

It is to be understood that both the foregoing general description and the following detailed description are exemplary and explanatory only and are not restrictive of the invention, as claimed.

### DETAILED DESCRIPTION

As used herein, “ambient conditions” refers to 72° F. and 45% humidity.

As used herein, “inert to conductivity” means that the material does not conduct or resist electrical charge.

As used herein, “water contact angle” is measured using droplets of water that are placed onto a 304 stainless steel surface that has been treated with the described polymer(s). For example, the first polymer having a water contact angle greater than 90 degrees after curing means that a 304 stainless steel surface has been coated with the first polymer, which is then cured prior to a droplet of water being dropped thereon. The same is true for the water contact angle for the second polymer.

Other contact angles were also used to determine the hydrophobic properties of the described coatings placed on different substrates. For example, water contact angles and oil contact angles are described herein that were measured on treated glass slides and treated aluminum substrates. The methods used to measure these contact angles are similar to those described for the treated 304 stainless steel surface.

To protect an electronic device from contaminants, such as water, there is disclosed a method of applying to at least one component of a device, multiple polymeric layers that form a hydrophobic coating that is inert to conductivity.

There is disclosed a method of protecting an electronic device by applying a combination of polymeric materials to the components of an electronic device. In one embodiment, the method comprises applying a first layer comprising a first polymer to a component, and applying a second layer on top of the first layer, the second layer comprising a second polymer. Both the first layer and the second layer exhibit hydrophobic properties, as determined by a water contact angle greater than 90 degrees such that the first layer and second layer form a multilayer, hydrophobic coating on top of the internal component. In one embodiment, the first and second polymers have a water contact angle of at least 110°, such as 115° or greater, or any contact angle ranging from 100 to 120°.

In one embodiment, the first polymer comprises a silicone-based polymer. A non-limiting example of the silicone-based polymer that can be used according to the present disclosure is an aliphatic siloxane represented by the following formula I:

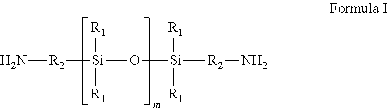

The silicone-based polymer may further comprises at least one hydrophobic agent, such as an organometallic compound. In one embodiment, the organometallic halogen material comprises at least one alkyl group and at least one halogen atom linked to a metal atom. Non-limiting examples of the metal atom include titanium, zirconium, tantalum, germanium, boron, strontium, iron, praseodymium, erbium, cerium, lithium, magnesium, aluminum, phosphorus and silicon.

In one embodiment, the method further comprises curing the silicone-based polymer to form a cured first layer prior to applying the second layer. Curing of the silicone-based polymer typically comprises exposing the polymer to ambient conditions for at least 30 minutes. Alternatively, curing may be done under thermal conditions, such as heating above 80° C., such as from 90-110° C. for a time sufficient to cure the polymer. Such times range are typically up to 5 minutes, but may range from 2 to 10 minutes depending on the polymer composition and layer thickness. In one embodiment, the thickness of the first layer is 1 micron or less.

In one embodiment, the second polymer comprises an acrylic-based polymer. A non-limiting example of the acrylic-based polymer that can be used according to the present disclosure is a fluorinated, acrylic-based polymer represented by the following formula (II):

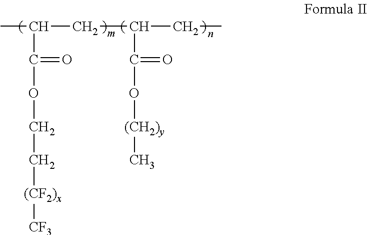

The method may further comprise curing the second layer. Curing of the fluorinated, acrylic-based polymer typically comprises exposing the polymer to ambient conditions for at least 24 hours. Like the first layer, curing of the second layer may be done under thermal conditions, for times less than 24 hours. Again curing is done at a temperature and for a time sufficient to cure the polymer material and thickness of the second layer. In one embodiment, the thickness of the second layer is 1 micron or less.

In one embodiment, the combined thickness of the first and second layer is 2 microns or less. These first and second layers can be applied by at least one automated or manual deposition technique chosen from dipping, spraying, vacuum deposition, and wipe coating. Additional steps may be carried out before or after applying the first and/or second layer. For example, in one embodiment, the method may further comprise cleaning the electronic component prior to applying the first layer to remove dust, grime or other surface dirt.

Non-limiting examples of the electronic component that may be coated using the disclosed method include a power switch, a volume switch, a light, a liquid crystal display, a touchscreen, a touch panel, a camera, an antenna, an internal connector, such as a printed circuit board, and combinations thereof.

It is understood that when the internal connector has a male end and a female end, the method comprises applying the multilayered, hydrophobic coating to both the male end and the female end of the connector prior to connecting the male end to the female end.

There is also disclosed an electronic device that is protected from contaminants, such as water, because it comprises a hydrophobic polymer layers on at least one internal component. Non-limiting examples of at least one or more devices that can be protected using the disclosed method include a cellular phone, a personal digital assistant (PDA), a tablet, a notebook, a laptop, a desktop computer, a music player, a camera, a video recorder, a battery, an electronic reader, a radio device, a gaming device, a server, headphones, terminal blocks, and control panels. In addition, other devices that can be protected using the disclosed method include a wearable device, a medical device, a radio controlled device, an industrial device, an appliance device.

The hydrophobic coating used to protect such devices comprises a first layer that is in direct contact with an internal component, wherein the first layer comprises a first polymer as described herein. In one embodiment, the second layer is located on top of the first layer and comprises a second polymer, as described herein.

As discussed, both the first layer and the second layer exhibit hydrophobic properties, as determined by a water contact angle greater than 90 degrees such that the first layer and second layer form a multilayer, hydrophobic coating on top of the internal component. In one embodiment, the first and second polymers have a water contact angle of at least 110°, such as 115° or greater, or any contact angle ranging from 100 to 120°.

It has been discovered that electronic devices that have been protected as described herein, have increased water resistance by at least one order of magnitude, as measured by the time to malfunction when immersed in water. In particular, the Inventors have discovered that by providing the multilayer, hydrophobic coating as a barrier layer on the vital, and highly susceptible parts of an electronic device, water resistance of the device can increase at least 10 times, such as more than 25 times, or even more than 50 times when compared to an unprotected device. Furthermore, because the multilayer, hydrophobic coating described herein is inert to conductivity, it does not interfere with the function of the resulting electronic device, while adding the improved water resistance.

Low surface tension of the coating solution as disclosed herein provides increased surface wetting, especially under low profile components. The coatings described herein also provides excellent repellency, anti-wetting and anti-sticking properties against fluids, including but not limited to water, hydrocarbons, silicones and photoresists. As a result, the dried film has low surface energy allowing water-based liquids to bead and drain freely.

In addition the coating described herein provides a layer of chemical protection to the treated device, as the dried multiplayer film is insoluble in solvents such heptane, toluene and water

An additional benefit associated with the multilayer polymers described herein in their flexibility. As these layers do not require thermal treatment, or harsh chemicals, they can be applied to many different substrates, including glass, metals, such as aluminum, stainless, and polymers.

The features and advantages of the present invention are more fully shown by the following examples which are provided for purposes of illustration, and are not to be construed as limiting the invention in any way.

The following description provides a step-by-step process of protecting a smart phone from contaminants by applying a multilayered, hydrophobic coating on the various components of the smart phone prior to final assembly of the device.

The process started on a disassembled smart phone. A single drop of a silicone polymer, i.e., the aliphatic siloxane described above and shown in Formula I, having an organometallic compound (“Polymer 1”) was dispensed on the power switch and volume switches only. Polymer 1 was then thoroughly coated on entire back side of the printed circuit board (PCB), including on all female base connectors to allowing Polymer 1 to flow inside all metal covers.

Next, Polymer 1 was applied thoroughly over entire front side of the PCB including all female base connectors, again allowing Polymer 1 to flow inside all metal covers. A single drop of Polymer 1 was then dispensed on the male connector of each ribbon. After each coating step, Polymer 1 was then cured for at least 30 minutes before the fluorinated, acrylic-based polymer described above and shown in Formula II (“Polymer 2”) was deposited on Polymer 1 to form a multilayer polymer structure.

The second layer of the multilayer structure was applied by first dispensing Polymer 2 around all outer areas of the female base connectors, followed by dispensing Polymer 2 around all outer male connectors.

The various components that were already coated with both Polymer 1 and Polymer 2 were connected to back side connectors on the PCB, and Polymer 2 was applied on the sides of all connectors until full wicking around perimeter occurred.

Next, the PCB was installed into its housing, and the various components were installed on the front side of the PCB to female base connectors that were mounted on the PCB. Again, Polymer 2 was applied on the side of each connector until full wicking around perimeter occurred.

The male screen connector was then installed to the female base connector mounted to the PCB. Once more, Polymer 2 was applied on the side of each connector until full wicking around the perimeter occurred. Finally, the smart phone was fully assembled by placing the battery and back cover on the device.

The smart phone protected by this process was then tested to determine the efficacy of the inventive process. It was discovered that a smart-phone device protected with the multilayered hydrophobic coating according to the present disclosure exhibited at least one order of magnitude longer protection time when compared to the same device not protected with the disclosed hydrophobic coating. The properties of the post treatment coating are provided in Table 1.

TABLE 1
Physical Properties of Post Treatment Coating

| | |
|---|---|
| Coating Thickness | <1 micron |
| Visible Light Transmission | 100%, |
| | no change to substrate |
| Water Contact Angle | 115° |
| (treated 304 stainless steel)* | |
| Oil Contact Angle | 19° |
| (treated 304 stainless steel)* | |
| Water Contact Angle (treated glass slides)** | 110° |
| Oil Contact Angle (treated glass slides)** | 24° |
| Water Contact Angle (treated aluminum)*** | 115° |
| Oil Contact Angle (treated aluminum)*** | 19° |
| Sliding Angle of Water Droplet (10 mL distilled | >90° |
| water)**** | |

*Stainless steel substrates were 304 alloy 1/32″ foil, mill finish supplied by McMaster-Carr.
**Glass slides were “Opticlear*” supplied by Fisher Scientific.
***Aluminum substrates were 1/32″ 6061 alloy supplied by Q-Panel.
****Abrasion testing is performed using cotton cloth 437W from TestFabrics, Inc. 100 abrasion cycles at 120 g/cm².

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A method of protecting an electronic device from contaminants, said method comprising:
applying to at least one internal component of a device a combination of polymers comprising: a first layer comprising a first polymer having a water contact angle greater than 90° after curing; and a second layer comprising a second polymer having a water contact angle greater than 90° after curing, wherein the first polymer and the second polymer form a multilayer, hydrophobic coating on top of the at least one internal component of said electronic device.

2. The method of claim 1, wherein the first polymer and the second polymer exhibit contact angles ranging from 100 to 120° after curing.

3. The method of claim 1, wherein the first polymer comprises a silicone-based polymer, and the second polymer comprises an acrylic-based polymer.

4. The method of claim 3, wherein the first polymer comprises an aliphatic siloxane represented by the following formula: 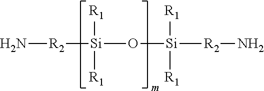
and the second polymer comprises a fluorinated, acrylic-based polymer represented by the following formula:

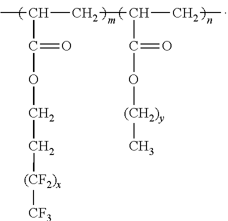

5. The method of claim 1, further comprising curing the first polymer to form a cured first layer prior to applying the second layer, wherein curing the first polymer comprises exposing the polymer to ambient conditions for at least 30 minutes, or exposing the polymer to a temperature ranging from 90-110° C. for up to 5 minutes.

6. The method of claim 1, further comprising curing the second layer by exposing the second polymer to ambient conditions for at least 24 hours.

7. The method of claim 1, comprising applying the first and second layers in a thickness of 1 micron or less by at least one automated or manual deposition technique chosen from dipping, spraying, vacuum deposition, and wipe coating.

8. The method of claim 1, wherein said at least one internal component of a device is a power switch, a volume switch, a light, a liquid crystal display, a touchscreen, a touch panel, a camera, an antenna, an internal connector, and combinations thereof, wherein the internal connector comprises a printed circuit board, a button, a higher voltage component, and combinations thereof, wherein when the internal connector has a male end and a female end, the method comprising applying the multilayered, hydrophobic coating to both the male end and the female end of the connector prior to connecting the male end to the female end.

9. The method of claim 1, further comprising assembling the device by contacting the coated components to form an operational device having improved hydrophobic properties compared to a device without the coated components.

10. An electronic device comprising:
a first layer in direct contact with an internal component, the first layer comprising a first polymer having a water contact angle greater than 90°; and
a second layer on top of the first layer, the second layer comprising a second polymer having a water contact angle greater than 90°,
wherein the first layer and the second layer form a multilayer, hydrophobic coating on top of the at least one internal component.

11. The electronic device of claim 10, wherein the at least one multilayered, hydrophobic coating is inert to conductivity.

12. The electronic device of claim 10, wherein said first polymer and said second polymer exhibit contact angles ranging from 100 to 120° after curing.

13. The electronic device of claim 10, wherein the first polymer comprises a silicone-based polymer, and the second polymer comprises an acrylic-based polymer.

14. The electronic device of claim 13, wherein the first polymer comprises an aliphatic siloxane represented by the following formula:

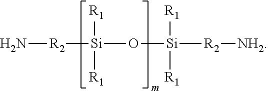

15. The electronic device of claim 13, wherein the second polymer comprises a fluorinated, acrylic-based polymer represented by the following formula:

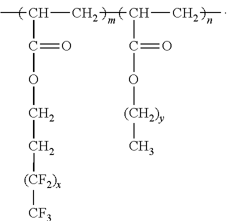

16. The electronic device of claim 10, wherein said one or more component comprises a power switch, a volume switch, a light, a liquid crystal display, a touchscreen, a touch panel, a camera, an antenna, an internal connector, and combinations thereof, wherein said internal connector comprises a printed circuit board, a button, and a higher voltage component, and combinations thereof.

17. The electronic device of claim 16, wherein said internal connector has a male end, a female end, or both, and said multilayered, hydrophobic coating is located on both the male end and the female end of the connector.

18. The electronic device of claim 10, wherein said devices comprises a cellular phone, a personal digital assistant (PDA), a tablet, a notebook, a laptop, a desktop computer, a music player, a camera, a video recorder, a battery, an electronic reader, a radio device, a gaming device, a server, headphones, terminal blocks, control panels, a wearable device, a medical device, a radio controlled device, an industrial device, and an appliance device.

19. The electronic device of claim 10, wherein said device exhibits at least ten (10) times greater water resistance in terms of minutes immersed in water compared to the same device not containing said multilayer, hydrophobic coating.

20. The electronic device of claim 10, wherein the at least one multilayered, hydrophobic coating comprises first and second layers each having a thickness of 1 micron or less.
